(19) United States
(12) Patent Application Publication
(10) Pub. No.: US 2025/0184436 A1
(43) Pub. Date: Jun. 5, 2025

(54) INFORMATION PROCESSING APPARATUS AND METHOD OF CONTROLLING INFORMATION PROCESSING APPARATUS

(71) Applicant: Sharp Kabushiki Kaisha, Osaka (JP)

(72) Inventor: Hidemitsu IMAI, Osaka (JP)

(21) Appl. No.: 18/960,156

(22) Filed: Nov. 26, 2024

(30) Foreign Application Priority Data
Dec. 1, 2023 (JP) 2023-203812

(51) Int. Cl. H04N 1/00

(52) U.S. Cl. CPC H04N 1/00413; H04N 1/00281; H04N 2201/0039

(57) ABSTRACT

An information processing apparatus includes: one or more controllers; an operation acceptor; a displayer, and a communicator that provides a network port for connecting to a network. The one or more controllers accept an instruction to disable a first function via the operation acceptor, determine existence of a second function that uses a network port used by the first function and that is different from the first function, and decide whether or not to disable the network port, based on a result of the determination.

### BACKGROUND OF THE INVENTION

### Field of the Invention

The present disclosure relates to an information processing apparatus and the like.

### Description of the Background Art

In general, an information processing apparatus such as a multi-function printer/peripheral (MFP), an image forming apparatus, or an image processing apparatus has various functions, but a user does not always use all of these functions. For example, a user of an image forming apparatus does not use all functions of the image forming apparatus, and some functions are not used at all, depending on the user. In some image forming apparatuses, such unused functions can be disabled by setting.

On the other hand, in some image forming apparatuses, when a function of performing communication using a network port is disabled, security is improved by disabling not only the function but also the network port used by the function. In this type of image forming apparatus, when an unused function is disabled, a network port used by the function is also disabled.

Incidentally, a plurality of functions of the image forming apparatus may use the same network port. In this case, as a result of disabling the network port used by the unused function, other functions are no longer be able to use the network port. As a result, a function that the user does not intend to disable may also be substantially disabled.

In relation to the present disclosure, a network connection terminal management system that includes “a plurality of network connection terminals for connecting terminals to a network” and that “performs management of individually enabling or disabling functions of the network connection terminals” is known as the related art.

According to the related art, a use of one network connection terminal by a plurality of functions is not considered. For this reason, a problem that when a certain function and a network connection terminal used by the function are disabled, other functions using the same network connection terminal cannot be used, and a way to solve this problem are not known.

An object to be achieved by the present disclosure is to provide an information processing apparatus capable of preventing a function not intended by a user from being disabled by disabling a function using a network port.

### SUMMARY OF THE INVENTION

The present disclosure provides an information processing apparatus including one or more controllers, an operation acceptor, a displayer, and a communicator that is connected to a network and that provides a network port, in which the one or more controllers accept an instruction to disable a first function via the operation acceptor, determine existence or non-existence of a second function that uses the network port used by the first function and that is different from the first function, and decide whether or not to disable the network port, based on a result of the determination.

Furthermore, the present disclosure provides a method of controlling an information processing apparatus, the method including: accepting an instruction to disable a first function; determining existence or non-existence of a second function that uses a network port used by the first function and that is different from the first function; and deciding whether or not to disable the network port, based on a result of the determination.

According to the present disclosure, it is possible to provide an information processing apparatus capable of preventing a function not intended by a user from being disabled by disabling a function using a network port.

### BRIEF DESCRIPTION OF THE DRAWINGS

FIG. 1 is a diagram for describing a configuration of an information processing system of the present disclosure.

FIG. 2 is a diagram for describing a configuration of an image forming apparatus of the present disclosure.

FIG. 3 is a diagram for describing a table stored in a storage of the image forming apparatus of the present disclosure.

FIG. 4 is a flowchart for describing an operation of an image forming apparatus according to a first embodiment of the present disclosure.

FIG. 5 is an example of a function disabling screen displayed on a displayer of the image forming apparatus according to the first embodiment of the present disclosure.

FIG. 6 is an example of a screen displayed on a displayer of the image forming apparatus according to the first embodiment of the present disclosure.

FIG. 7 is a flowchart for describing an operation of an image forming apparatus according to a second embodiment of the present disclosure.

FIG. 8 is an example of a screen displayed on a displayer of the image forming apparatus according to the second embodiment of the present disclosure.

FIG. 9 is a flowchart for describing an operation of an image forming apparatus according to a third embodiment of the present disclosure.

FIGS. 10A and 10B are examples of screens displayed on a displayer of the image forming apparatus according to the third embodiment of the present disclosure.

FIGS. 11A and 11B are examples of screens displayed on the displayer of the image forming apparatus according to the third embodiment of the present disclosure.

FIG. 12 is an example of a screen displayed on the displayer of the image forming apparatus according to the third embodiment of the present disclosure.

FIG. 13 is a flowchart for describing an operation of an image forming apparatus according to a fourth embodiment of the present disclosure.

FIG. 14 is a flowchart for describing an operation of the image forming apparatus according to the fourth embodiment of the present disclosure.

FIG. 15 is an example of a screen displayed on a displayer of an image forming apparatus according to a fifth embodiment of the present disclosure.

FIGS. 16A and 16B are examples of screens displayed on the displayer of the image forming apparatus according to the third embodiment of the present disclosure.

FIGS. 17A and 17B are examples of screens displayed on a displayer of an image forming apparatus according to an example of the present disclosure.

FIG. 18 is a diagram for describing a table stored in a storage of the image forming apparatus according to the example of the present disclosure.

FIGS. 19A and 19B are examples of screens displayed on the displayer of the image forming apparatus according to the example of the present disclosure.

### DESCRIPTION OF THE PREFERRED EMBODIMENTS

### 1. FIRST EMBODIMENT

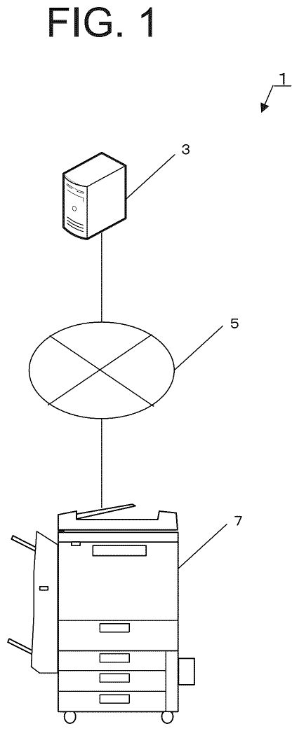

FIG. 1 is a diagram for describing a configuration of an information processing system according to the present disclosure. An information processing system 1 includes a server 3, a network 5, and an image forming apparatus 7. The image forming apparatus 7 provides various functions by communicating with the server 3 via the network 5. Such kinds of functions include, for example, AirPrint from Apple Inc. and Universal Print from Microsoft Corporation. Further, there is a function (print release function) of printing print data stored in an image forming apparatus set as a master unit from an image forming apparatus set as a slave unit when a plurality of compatible apparatuses exist on the same network.

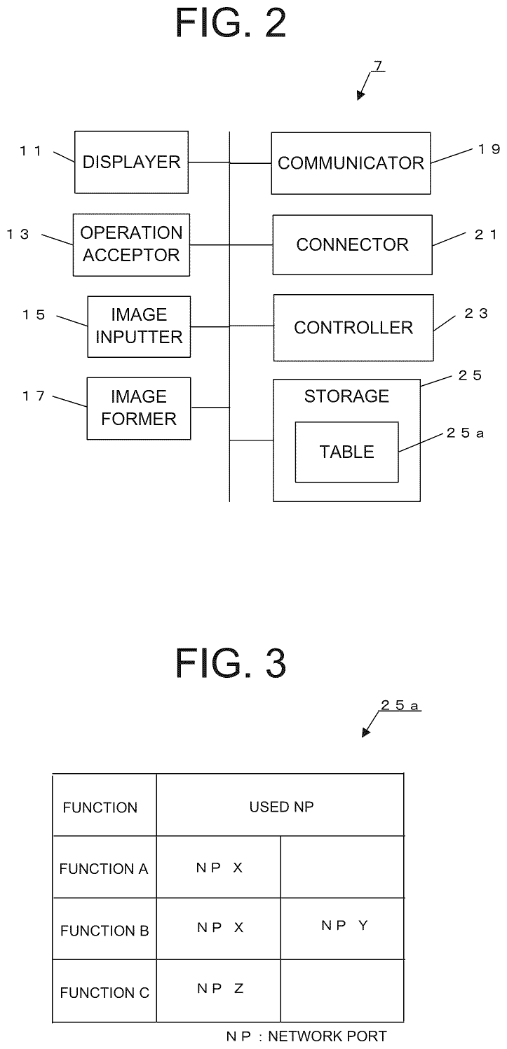

FIG. 2 is a diagram for describing a configuration of the image forming apparatus of the present disclosure. The image forming apparatus 7 is a multi-function printer/peripheral (MFP) or a multi-function device, and typically has a copy function, an image scanner function, a facsimile function, and a printer function. The image forming apparatus 7 may further include other functions, for example, an e-mail transmission/reception function, a file server function, and the like.

A displayer 11 displays an image and characters. The displayer 11 is constituted of, for example, a liquid crystal display (LCD), an organic electro-luminescence (EL) panel, or the like. The displayer 11 may be a single display device or may further include an externally connected display device.

An operation acceptor 13 accepts an operation input from a user. For example, the operation acceptor 13 includes a hardware key and/or a software key. The operation acceptor 13 includes operation keys such as a task key for instructing execution of a task such as FAX transmission or image reading and a stop key for instructing stop of an operation.

An image inputter 15 reads an image (original) and outputs the image as image data. The image inputter 15 is constituted of a common scanner (image input device). The image inputter 15 may input image data from an external storage medium such as a USB memory or may receive an image via a network.

An image former 17 forms (prints) an image on a medium such as a copy sheet, based on the image data. A printing method of the image former 17 is optional, and may be, for example, any one of an inkjet printer, a laser printer, a thermal transfer printer, and the like. The image former 17 may be a monochrome printer or a color printer. The image former 17 may include a paper feed mechanism that supplies a medium, a transport mechanism that transports a medium, a sorter mechanism that sorts a medium after an image is formed, and the like.

A communicator 19 connects to a network. The communicator 19 provides a network port for connecting to a network. For example, the communicator 19 is constituted of an interface that is connectable to a wired local area network (LAN), a wireless LAN, or a long term evolution (LTE) network. By connecting the communicator 19 to a network, the communicator 19 is connected to an other device or an external network. In addition, the communicator 19 may be, for example, an interface that performs short-range wireless communication, such as near field communication (NFC) or Bluetooth (registered trademark).

A connector 21 connects the image forming apparatus to an other device. For example, the connector 21 is a USB interface, to which a USB memory or the like is connected. The connector 21 may be an interface such as HDMI (registered trademark), in addition to the USB interface.

A controller 23 controls the entire image forming apparatus. The controller 23 is constituted of one or a plurality of control devices and control circuits, and is constituted of, for example, a central processing unit (CPU) which is a processor that executes various kinds of arithmetic processing, a system on a chip (SoC), and the like.

Further, the controller 23 can achieve each function by reading a program stored in a storage 25, and executing processing. In particular, the controller 23 opens a network port for performing communication with the server 3 via the network 5 using the communicator 19. The controller 23 achieves various functions by performing communication with the server 3 using the network port. The network port is a virtual network connection terminal for identifying a program used when the controller 23 performs communication such as Transmission Control Protocol/Internet Protocol (TCP/IP) communication with an external device such as the server 3, but may be a network connection terminal for connecting the image forming apparatus 7 to the network 5.

The storage 25 stores various types of data and various programs necessary for operation of the image forming apparatus. The storage 25 includes a recording device capable of transitory storage, such as a dynamic random access memory (DRAM), or a non-transitory recording device, such as a solid state drive (SSD) including a semiconductor memory or a hard disk drive (HDD) including a magnetic disc. Although the storage 25 is configured as a single unit for convenience of description, the storage 25 may be configured as a separate device for each purpose, such as an area used for execution of a program (primary storage area), an area for storing a program or data (auxiliary storage area), or an area used for a caching.

FIG. 3 is a diagram for describing a table stored in the storage of the image forming apparatus according to the present disclosure. A table 25a stores a correspondence relation between a function provided by the image forming apparatus 7 and a network port (denoted by NP in the drawing) used by the function. According to the table 25a, a function A uses a network port X, a function B uses network ports X and Y, and a function C uses a network port Z.

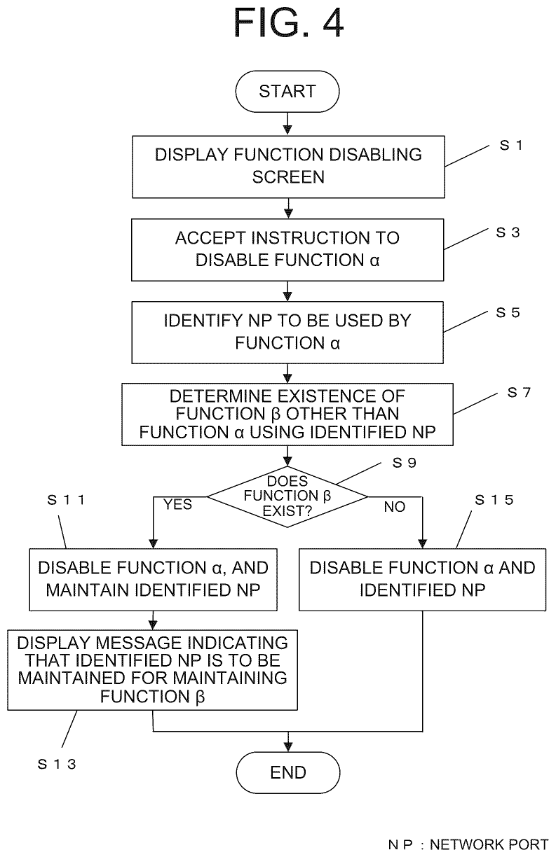

FIG. 4 is a flowchart for describing an operation of an image forming apparatus according to a first embodiment of the present disclosure. The controller 23 displays a function disabling screen on the displayer 11 (step S1). The function disabling screen is a screen for displaying a list of functions that can be disabled. The user views the function disabling screen displayed on the displayer 11, and inputs an instruction for a function to be disabled via the operation acceptor 13. Based on this input, the controller 23 accepts an instruction of the function to be disabled (step S3). Herein, a function instructed via the operation acceptor 13 is referred to as a function α (or a first function).

The controller 23 refers to a table 25a stored in the storage 25, and specifies a network port to be used by the function α (step S5). Herein, the network port used by the function α is referred to as a network port Q (NP Q).

Next, the controller 23 refers to the table 25a and determines existence or non-existence of a function other than the function α that uses the network port Q (NP Q) specified in step S5 (step S7). Herein, a function other than the function α, which uses the network port Q, is referred to as a function β (or a second function).

When the function β exists (step S9, YES), the controller 23 disables the function α, but does not disable the network port Q (step S11). The operation in this case is also referred to as a first option. Namely, in this case, the controller 23 maintains the network port Q. The controller 23 displays a message indicating that the network port Q is to be maintained on the displayer 11 (step S13), and ends a series of operations. This message desirably indicates that a reason for maintaining the network port Q is to maintain an enabled state of the function β. On the other hand, when the function β does not exist (step S9, NO), the controller 23 disables both the function α and the network port Q (step S15), and ends a series of operations. The operation in this case is also referred to as a second option.

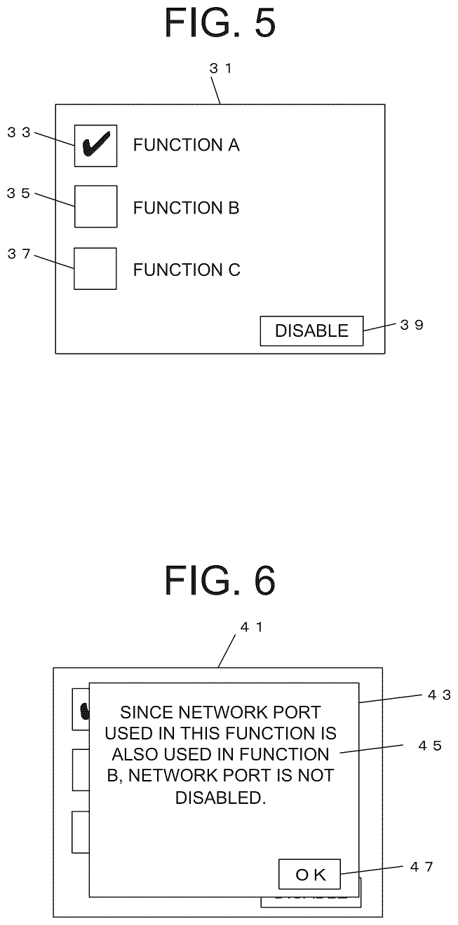

FIG. 5 is an example of a function disabling screen displayed on the displayer of the image forming apparatus according to the first embodiment of the present disclosure. A function disabling screen 31 is an example of the screen displayed in step S1 in FIG. 4. The function disabling screen 31 includes check boxes 33, 35, and 37 and a disabling button 39. The check boxes 33, 35, and 37 are screen elements corresponding to the function A, the function B, and the function C, respectively. The user of the image forming apparatus 7 views the function disabling screen 31 displayed on the displayer 11, and operates the operation acceptor 13, thereby checking the check box corresponding to the function desired to be disabled. When the disabling button 39 is operated via the operation acceptor 13, the controller 23 accepts the function corresponding to the check box checked at that time as a function to be disabled. In FIG. 5, since only the check box 33 corresponding to the function A is checked, when the disabling button 39 is operated in this state, the controller 23 accepts the function A as a function to be disabled.

FIG. 6 is an example of a screen displayed on the displayer of the image forming apparatus according to the first embodiment of the present disclosure. A screen 41 is an example of the screen displayed in step S13 in FIG. 4. The screen 41 includes a message box 43. The screen 41 is a screen in which a message box 43 is displayed superimposed on the function disabling screen 31. The message box 43 includes a message 45 and an OK button 47. The message 45 indicates that the network port used by the function designated by the user as the function to be disabled has not been disabled, and that the reason for this is that there is an other function that uses the same network port. The OK button 47 is a screen element for receiving an operation via the operation acceptor 13 when the user finishes reading the message 45.

For example, when the table 25a in FIG. 3 is stored in the storage 25 and the user operates the disabling button 39 in the state of the function disabling screen 31 in FIG. 5, the network port used by the function A is the network port X, and the function B is an other function that uses the network port X. Therefore, the network port that is not disabled in the message 45 in FIG. 6 is the network port X.

According to the first embodiment, when there is an other function that uses the same network port as a specific function designated to be disabled by the user, the specific function is disabled and the network port is not disabled. On the other hand, when there is no corresponding other function, both the specific function and the network port are disabled. Therefore, according to the first embodiment, a network port that is not used by a function other than the function to be disabled is disabled together with the function to be disabled, thereby improving the security. On the other hand, a network port that is used by the function other than the function to be disabled is maintained in the enabled state, thereby enabling to prevent the function not intended by the user from being disabled.

### 2. SECOND EMBODIMENT

A second embodiment will be described. The second embodiment is different from the first embodiment in operation when a function β exists. Herein, only differences in configuration and processing from the first embodiment will be mainly described. Also in the second embodiment, the information processing system 1 of FIG. 1 and the image forming apparatus 7 of FIG. 2 are used.

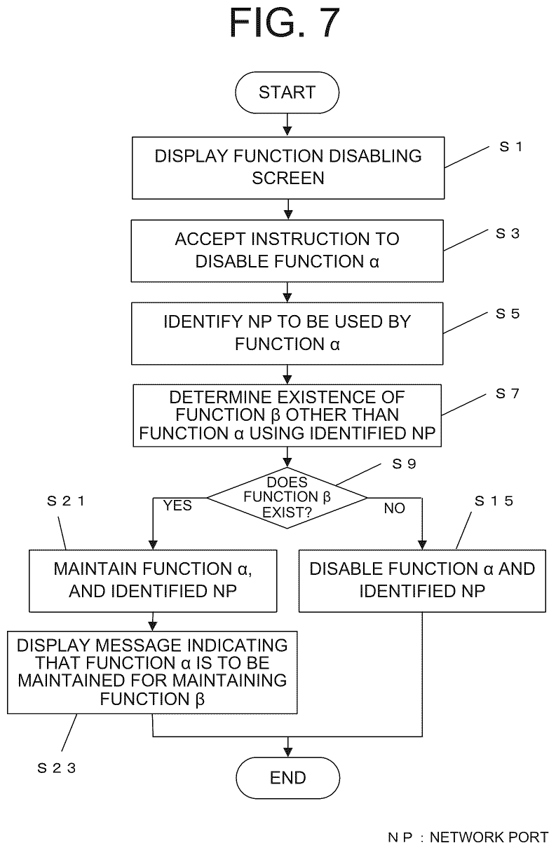

FIG. 7 is a flowchart for describing an operation of an image forming apparatus according to the second embodiment of the present disclosure. Steps S1 to S9 and S15 are the same as those in the first embodiment, and a description thereof will be omitted. In step S9, when the function β exists (step S9, YES), a controller 23 disables neither a function α nor a network port Q, i.e., maintains both the function α and the network port Q (step S21). The controller 23 displays, on the displayer 11, a message indicating that the function α is to be maintained (step S23). At this time, it is desirable to display that a reason for maintaining an enabled state of the function α is to maintain an enabled state of the function β.

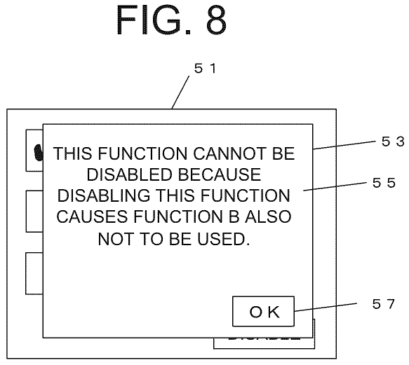

FIG. 8 is an example of a screen displayed on the displayer of the image forming apparatus according to the second embodiment of the present disclosure. A screen 51 is an example of the screen displayed in step S23 in FIG. 7. The screen 51 includes a message box 53. The screen 51 is a screen in which a message box 53 is displayed superimposed on a function disabling screen 31. The message box 53 has a message 55 and an OK button 57. The message 55 indicates that the function designated by a user as a function to be disabled has not been disabled, and the reason therefor is that when the function is disabled, other functions cannot be used. The OK button 57 is a screen element for receiving an operation via the operation acceptor 13 when the user finishes reading the message 55.

For example, when the table 25a in FIG. 3 is stored in a storage 25 and the user operates a disabling button 39 on the function disabling screen 31 in FIG. 5, a network port used by a function A is a network port X, and a function B is an other function that uses the network port X. Therefore, in the message 55 in FIG. 8, when the function A is disabled, the function B cannot be used, which means that the function A has not been disabled (although an instruction to disable the function A has been received in step S3).

According to the second embodiment, when there is an other function that uses the same network port as the specific function designated to be disabled by the user, enabled states of both the specific function and the network port are maintained. On the other hand, when there is no corresponding other function, both the specific function and the network port are disabled. Therefore, according to the second embodiment, by disabling a network port of a function not intended by the user, it is possible to prevent the function not intended by the user from becoming unavailable.

### 3. THIRD EMBODIMENT

A third embodiment will be described. The third embodiment is different from the first embodiment in operation when a function β exists. Herein, only differences in configuration and processing from the first embodiment will be mainly described. Also in the third embodiment, the information processing system 1 of FIG. 1 and the image forming apparatus 7 of FIG. 2 are used.

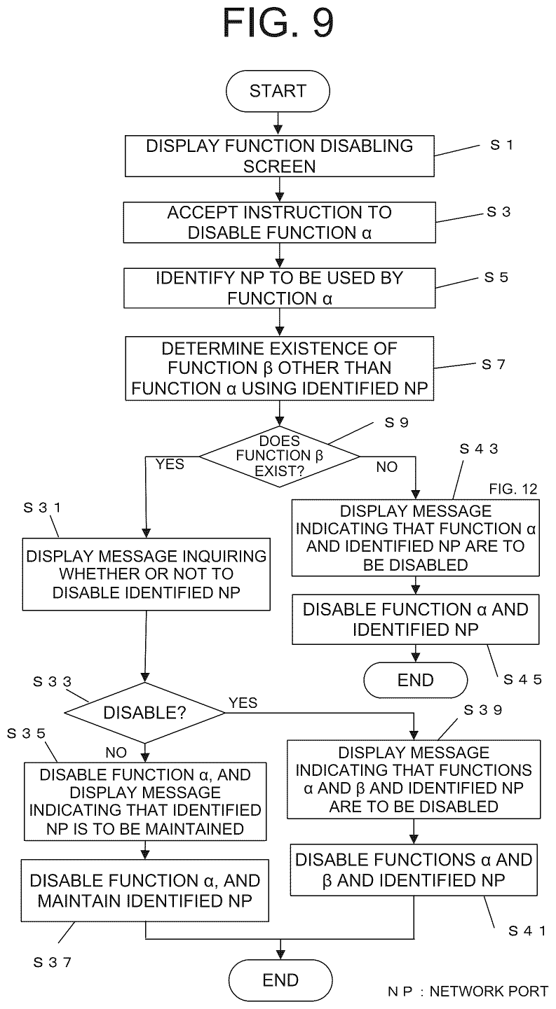

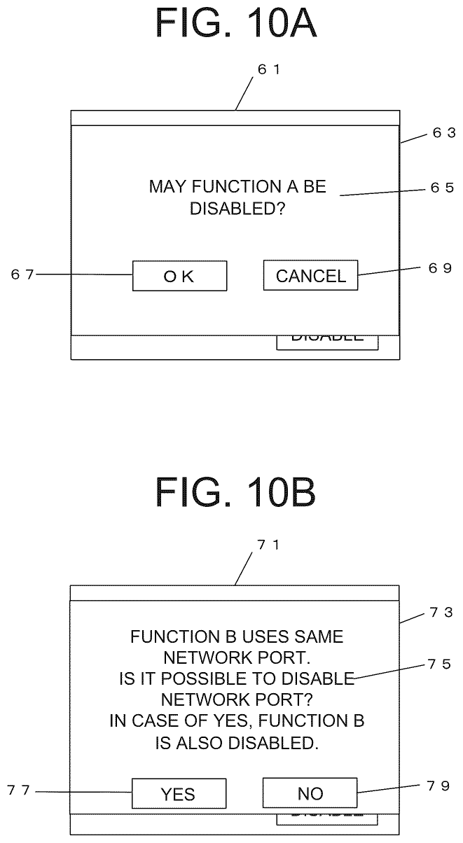

FIG. 9 is a flowchart for describing an operation of an image forming apparatus according to the third embodiment of the present disclosure. Steps S1 and S5 to S9 are substantially the same as in the first embodiment, and a description thereof will be omitted. In step S3, when an input instructing a function to be disabled is accepted via an operation acceptor 13, a controller 23 displays a response screen as illustrated in FIG. 10 to be described below.

In step S9, when a function β exists (step S9, YES), the controller 23 displays, on a displayer 11, a message inquiring whether or not to disable a network port Q (NP Q) specified in step S5 (step S31).

When an instruction input not to disable the network port Q is accepted via the operation acceptor 13 (step S33, NO), the controller 23 disables a function α, displays a message indicating that the network port Q is to be maintained, on the displayer 11 (step S35), disables the function α while maintaining the network port Q (step S37), and ends the processing.

When an instruction input to disable the network port Q is accepted via the operation acceptor 13 (step S33, YES), the controller 23 displays a message indicating that the functions α and β and the network port Q are to be disabled, on the displayer 11 (step S39), disables all of the functions α and β and the network port Q (step S41), and ends the processing.

In step S9, when the function β does not exist (step S9, NO), the controller 23 displays, on the displayer 11, a message indicating that both the function α and the network port Q are to be disabled (step S43), and disables both the function α and the network port Q (step S45).

FIG. 10A is an example of a screen displayed on the displayer of the image forming apparatus according to the third embodiment of the present disclosure. A screen 61 is an example of the screen displayed in step S3 in FIG. 9. The screen 61 is displayed, for example, when the disabling button 39 is operated in a state where a check box corresponding to the function to be disabled is checked on the function disabling screen 31 in FIG. 5. The screen 61 includes a message box 63, a message 65, an OK button 67, and a cancel button 69.

The message 65 is a message for confirming whether or not the function corresponding to the check box checked when the disabling button 39 is operated may be disabled. When the OK button 67 is operated via the operation acceptor 13, the controller 23 accepts the operation as an instruction indicating that the function may be disabled. When the cancel button 69 is operated via the operation acceptor 13, the controller 23 accepts the operation as an instruction to cancel the disabling of the function.

FIG. 10B is an other example of a screen displayed on the displayer of the image forming apparatus according to the third embodiment of the present disclosure. A screen 71 is an example of the screen displayed on the displayer 11 in step S31 in FIG. 9. The screen 71 includes a message box 73, a message 75, a YES button 77, and a NO button 79.

The message 75 is a message having the following purpose.
To notify the user that a function B using the same network port (network port X) as a function A to be disabled.
To notify the user that the function B is disabled when the network port X is disabled.
To inquiry of the user whether or not to disable the network port X.

When the YES button 77 is operated via the operation acceptor 13, the controller 23 determines that an instruction to disable the network port Q has been accepted, and the processing proceeds to “YES” in step S33. When the NO button 79 is operated via the operation acceptor 13, the controller 23 determines that an instruction not to disable the network port Q is accepted in step S33, and the processing proceeds to “NO” in step S33.

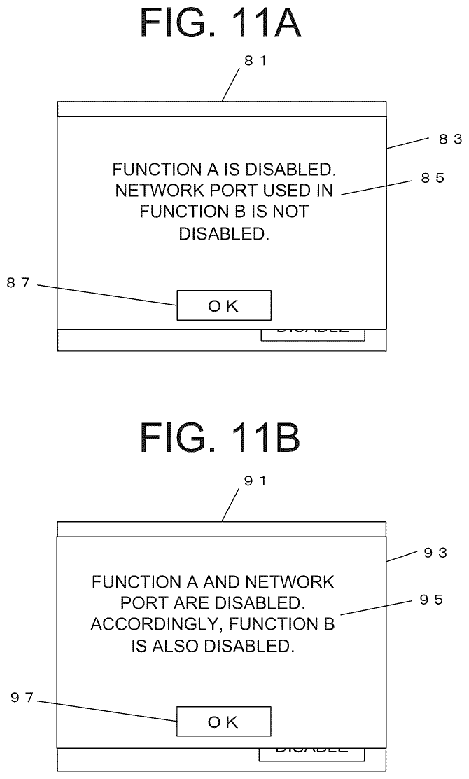

FIG. 11A is an example of a screen displayed on the displayer of the image forming apparatus according to the third embodiment of the present disclosure. A screen 81 is an example of the screen displayed on the displayer 11 in step S35 in FIG. 9. The screen 81 includes a message box 83, a message 85, and an OK button 87.

The message 85 informs the user that the function A has been disabled and that the network port (network port X) used by the function A is to be maintained. The message 85 desirably includes, as a reason for maintaining the network port X, that function B uses the network port X. When the OK button 87 is operated via the operation acceptor 13, the controller 23 determines that the user has read the message 85, and the processing proceeds to the next step.

FIG. 11B is an example of a screen displayed on the displayer of the image forming apparatus according to the third embodiment of the present disclosure. A screen 91 is an example of the screen displayed on the displayer 11 in step S39 in FIG. 9. The screen 91 includes a message box 93, a message 95, and an OK button 97.

The message 95 notifies the user that the function A and the network port have been disabled, and that the function B has been disabled accordingly. When the OK button 97 is operated via the operation acceptor 13, the controller 23 determines that the user has read the message 95, and the processing proceeds to the next step.

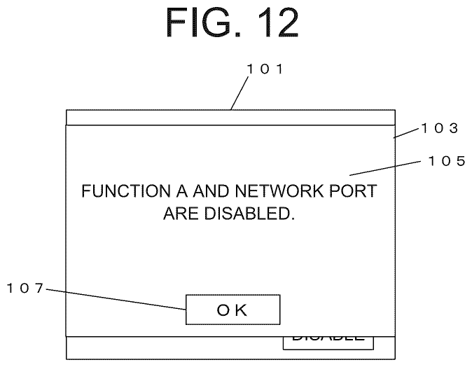

FIG. 12 is an example of a screen displayed on the displayer of the image forming apparatus according to the third embodiment of the present disclosure. A screen 101 is an example of the screen displayed on the displayer 11 in step S43 in FIG. 9. The screen 101 includes a message box 103, a message 105, and an OK button 107. The message 105 notifies the user that the function A and the network port have been disabled. When the OK button 107 is operated via the operation acceptor 13, the controller 23 determines that the user has read the message 105, and the proceeding proceeds to the next step.

According to the third embodiment, when there is an other function that uses the same network port as a specific function to be disabled (step S9, YES), the user is inquired about whether or not to disable the network port (step S31). According to the user's response to the inquiry, it is possible to select whether to disable only the specific function (step S33, NO) or to disable all of the specific function, the other function, and the network port (step S33, YES).

### 4. FOURTH EMBODIMENT

A fourth embodiment will be described. An operation in the fourth embodiment is partially different from that of the third embodiment. Herein, only differences in configuration and processing from the third embodiment will be mainly described. Also in the fourth embodiment, the information processing system 1 in FIG. 1 and the image forming apparatus 7 in FIG. 2 are used.

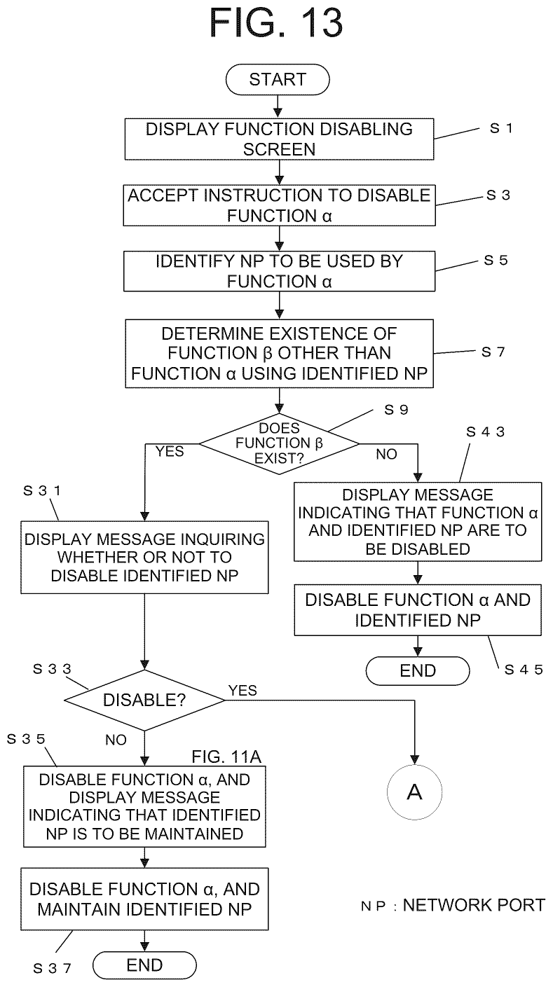

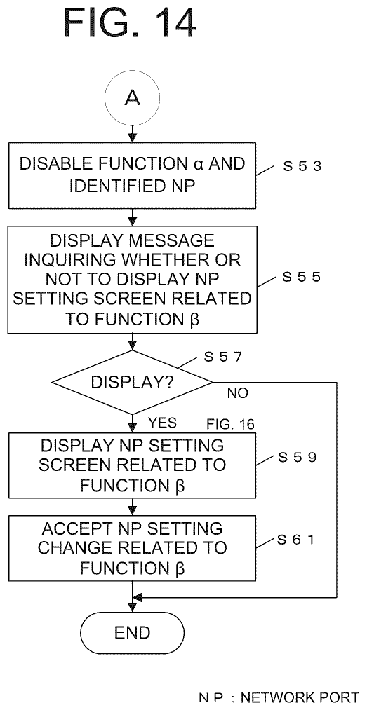

FIG. 13 is a flowchart for describing an operation of an image forming apparatus according to the fourth embodiment of the present disclosure. The operation after “YES” in step S33 is different from the flowchart in FIG. 9, and will be described with reference to the next FIG. 14.

FIG. 14 is a flowchart for describing an operation of the image forming apparatus according to the fourth embodiment of the present disclosure. In step S33, when an instruction input to disable a network port is accepted via an operation acceptor 13, a controller 23 disables both a function α for which an instruction to disable has been accepted in step S3 and a network port Q used by the function α (step S53). The controller 23 displays, on a displayer 11, a message inquiring whether or not to display a network port setting screen for a function β that uses the network port Q (step S55). In response to the message displayed in step S55, when an instruction input to display the message is accepted via the operation acceptor 13 (step S57, YES), the controller 23 displays a setting screen of the network port related to the function β (step S59), accepts a setting change of the network port related to the function β (step S61), and ends the processing. When an instruction input indicating that the message displayed in step S55 is not to be displayed is accepted via the operation acceptor 13 (step S57, NO), the controller 23 immediately ends the processing.

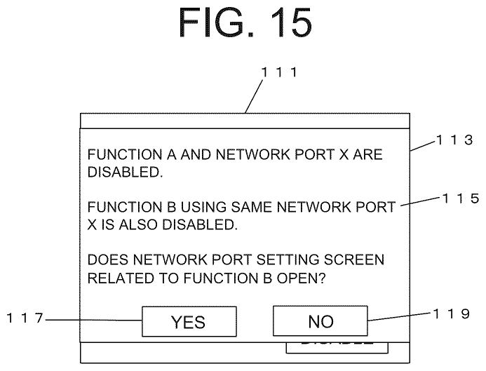

FIG. 15 is an example of a screen displayed on the displayer of the image forming apparatus according to the fourth embodiment of the present disclosure. A screen 111 is an example of the screen displayed on the displayer 11 in step S55 in FIG. 14. The screen 111 includes a message box 113, a message 115, a YES button 117, and a NO button 119.

The message 115 has the following purposes.
To notify a user that the function α to be disabled, which is designated in step S3, and the network port Q used by the function α have been disabled.
To notify the user that the other function β using the network port Q has been disabled.
To inquire of the user whether or not to open a setting screen of the network port related to the function β.

When the YES button 117 is operated via the operation acceptor 13, the controller 23 determines that an instruction input to open the setting screen of the network port related to the function β has been accepted (step S57, YES), and the processing proceeds to step S59. When the NO button 119 is operated via the operation acceptor 13, the controller 23 determines that an instruction input indicating that the setting screen of the network port related to the function β is not opened has been accepted (step S57, NO), and ends the processing.

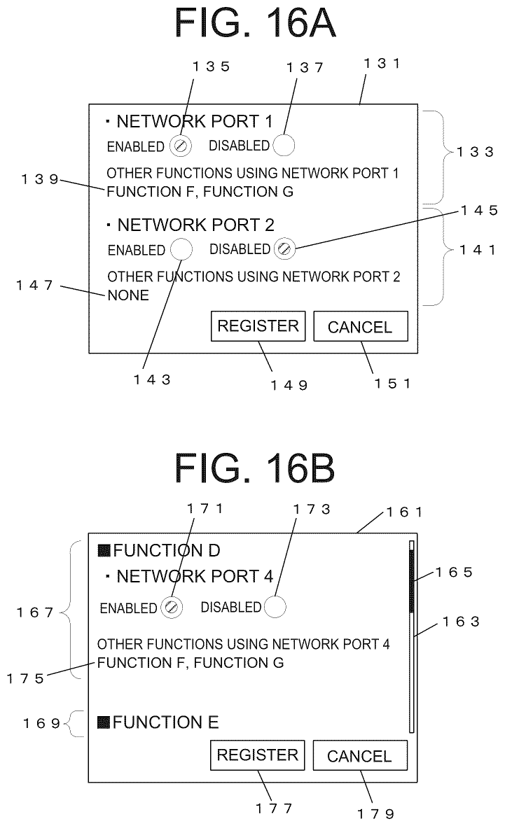

FIG. 16A is an example of a screen displayed on the displayer of the image forming apparatus according to the fourth embodiment of the present disclosure. A screen 131 is an example of the screen displayed on the displayer 11 in step S59 in FIG. 14. The screen 131 is an example of a screen when the number of functions that use the same network port Q as the function a to be disabled, which is designated in step S3, is one, and the number of network ports other than the network port Q (herein, referred to as network ports 1 and 2), which is used by the function, is two. Note that although a means of switching between enabling/disabling the network ports 1 and 2 (radio buttons 135, 137, 143, and 145) are displayed on the screen 131, in addition to these means, a means for switching between enabling and disabling the network port Q (for example, a radio button) may be displayed on the screen 131. In this way, the related network ports can be collectively set in one screen.

The screen 131 has areas 133 and 141. The area 133 includes the radio buttons 135 and 137 and a function display 139. The area 141 includes the radio buttons 143 and 145 and a function display 147. The screen 131 also includes a registration button 149 and a cancel button 151.

The area 133 is an area related to the network port 1. The radio buttons 135 and 137 are screen elements one of which enters a selected state by being operated via the operation acceptor 13, and indicate enabling and disabling of the network port 1, respectively. In FIG. 16A, the radio button 135 is in a selected state, and the network port 1 is set to be enabled. The function display 139 displays other functions using the network port 1. A display content of the function display 139 is determined by the controller 23, based on the table 25a. In FIG. 16A, functions F and G are displayed as other functions using the network port 1.

The area 141 is an area related to the network port 2. The radio buttons 143 and 145 are screen elements one of which enters a selected state by being operated via the operation acceptor 13, and indicate that the network port 2 is made enabled and disabled, respectively. In FIG. 16A, the radio button 145 is in the selected state, and the network port 2 is set to be deactivated. The function display 147 displays a use state of the network port 2 by other functions. A display content of the function display 147 is decided by the controller 23, based on the table 25a. Herein, since there is no other function that uses the network port 2, “none” is displayed.

When the registration button 149 is operated via the operation acceptor 13, the controller 23 enables or disables the network ports 1 and 2, based on the selection states of the radio buttons 135, 137, 143, and 145 at the time of the operation. When the cancel button 151 is operated via the operation acceptor 13, the controller 23 ends a series of processes without changing the enabling/disabling settings for the network ports 1 and 2.

FIG. 16B is an example of a screen displayed on the displayer of the image forming apparatus according to the fourth embodiment of the present disclosure. A screen 161 is an other example of the screen displayed on the displayer 11 in step S59 in FIG. 14. The screen 161 is an example of a screen when there are a plurality of functions that use the same network port Q as the function α to be disabled, which is designated in step S3. According to the screen 161 displayed as in FIG. 16B, it can be seen that at least functions D and E are functions that use the network port Q.

The screen 161 includes a scroll bar 163 and a knob 165. The screen 161 has areas 167 and 169. The area 167 corresponds to the function D and includes radio buttons 171 and 173 and a function display 175. The area 169 corresponds to the function E.

The screen 161 has an area further below the area 169. When the knob 165 of the scroll bar 163 is operated via the operation acceptor 13, the controller 23 displays an unillustrated area below the area 169 in the screen 161. For example, by a scroll operation using the knob 165, a network port used by the function E, a radio button for setting enabling/disabling of the network port, and a function display of an other function using the network port are displayed. In addition, by a scroll operation using the knob 165, areas for functions other than the functions D and E, for example, functions F, G, H, and the like are displayed. A registration button 177 and a cancel button 179 are similar to the registration button 149 and the cancel button 151 described above.

According to the fourth embodiment, in addition to the same effects as those of the third embodiment, by reviewing the setting of the network port related to the function β, for example, the network port used only by the function β is disabled, and it is possible to further improve security.

### 5. EXAMPLE

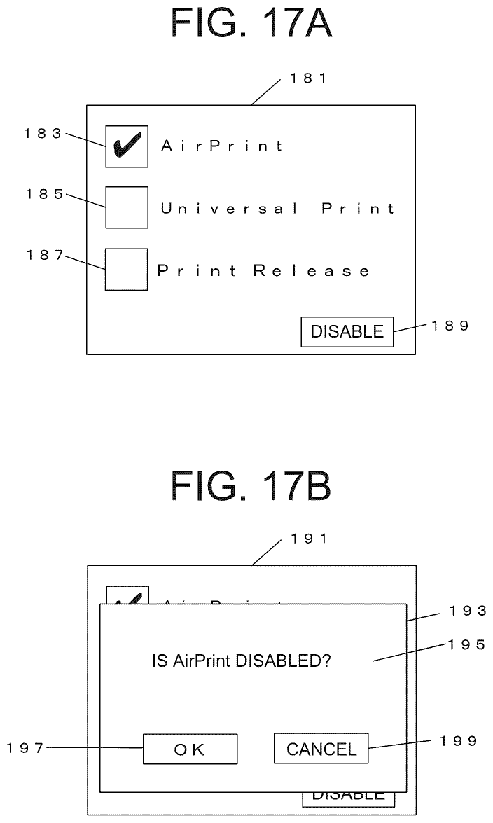

FIG. 17A is an example of a screen displayed on a displayer of the image forming apparatus according to an example of the present disclosure. A screen 181 is a more specific example of the function disabling screen 31 in FIG. 5. AirPrint, Universal Print, and Print Release on the screen 181 correspond to the functions A, B, and C on the function disabling screen 31, respectively. The screen 181 includes check boxes 183, 185, and 187 corresponding to these functions. In addition, the screen 181 includes a disabling button 189 corresponding to the disabling button 39.

FIG. 17B is an example of a screen displayed on the displayer of the image forming apparatus according to the example of the present disclosure. A screen 191 is a more specific example of the screen 61 in FIG. 10A. In the screen 191, AirPrint is used as the function A. An OK button 197 and a cancel button 199 respectively correspond to the OK button 67 and the cancel button 69.

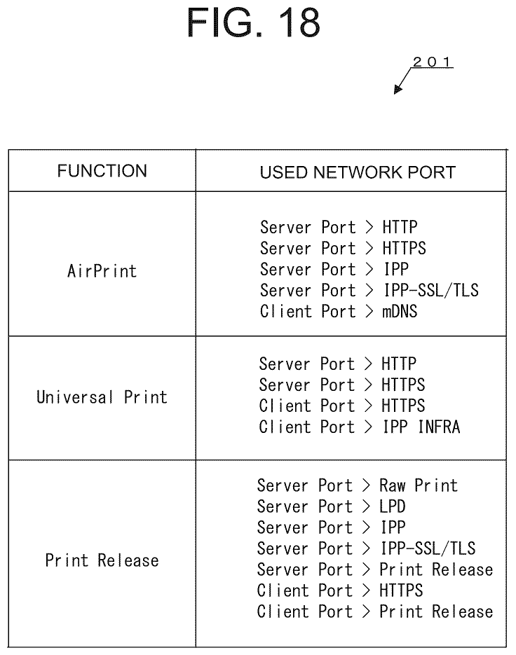

FIG. 18 is a diagram for describing a table stored in a storage of the image forming apparatus according to the example of the present disclosure. A table 201 corresponds to the table 25a in FIG. 3. AirPrint, Universal Print, and Print Release in the table 201 correspond to the functions A, B, and C in the table 25a, respectively. In the table 201, a plurality of network ports are stored in association with each other as network ports used by the function AirPrint. The same applies to the functions Universal Print and Print Release. The functions AirPrint, Universal Print, and Print Release may use the same network port or different network ports. For example, the functions AirPrint and Universal Print both use HTTP, HTTPS as Server Port.

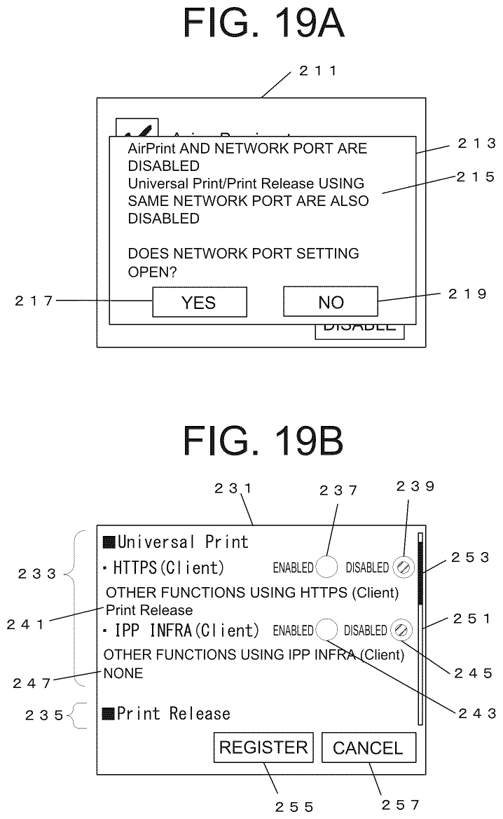

FIG. 19A is an example of a screen displayed on the displayer of the image forming apparatus according to the example of the present disclosure. The screen 211 is a more specific example of the screen 111 in FIG. 15. In the screen 211, AirPrint corresponds to the function A in the screen 111, and Universal Print corresponds to the function B in the screen 111. A YES button 217 and a NO button 219 respectively correspond to the YES button 117 and the NO button 119.

FIG. 19B is an example of a screen displayed on the displayer of the image forming apparatus according to the example of the present disclosure. A screen 231 is a more specific example of the screen 161 in FIG. 16B. Universal Print on the screen 231 corresponds to the function D on the screen 161, and Print Release on the screen 231 corresponds to the function E on the screen 161. Both HTTPS (Client) and IPPINFRA (Client) on the screen 231 correspond to the network port 4 on the screen 161. Function displays 241 and 247 on the screen 231 correspond to the function display 175 on the screen 161. Radio buttons 237 and 243 on the screen 231 both indicate “enabled”, and both correspond to the radio button 171 on the screen 161. Radio buttons 239 and 245 on the screen 231 both indicate “disabled”, and the both correspond to the radio button 173 on the screen 161. Areas 233 and 235 correspond to the areas 167 and 169 on the screen 161, respectively. A scroll bar 251 and a knob 253 on the screen 231 correspond to the scroll bar 163 and the knob 165 on the screen 161. A registration button 255 and a cancel button 257 on the screen 231 respectively correspond to the registration button 177 and the cancel button 179 on the screen 161.

### 6. MODIFIED EXAMPLE

The present disclosure is not limited to the embodiments as described above and modifications, but is diversely changeable. In other words, an embodiment to be acquired by combining technical measures modified as appropriate within a range that does not depart from the gist of the present disclosure are also included in the technical scope of the present disclosure.

The program, which operates in each apparatus of the embodiments, is a program that controls the CPU or the like (a program causing a computer to function) in such a way as to achieve the functions of the embodiments as described above. Information to be handled by these devices is temporarily accumulated in a temporary storage device (e.g., RAM) during processing the information, and then stored in various storage devices such as read only memory (ROM) and an HDD, and is read, corrected, and written by the CPU as needed.

A recording medium storing a program may be any of a semiconductor medium (e.g., a ROM, a non-volatile memory card, etc.), an optical recording medium or a magneto-optical recording medium (e.g., a digital versatile disc (DVD), a magneto optical disc (MO), a mini disc (MD), a compact disc (CD), a Blue-ray disc (BD (registered trademark)), etc.), a magnetic recording medium (e.g., a magnetic tape, a flexible disc, etc.), and the like. Further, the functions of the embodiments as described above are achieved not only by executing the loaded program, but the functions of the present disclosure may be also achieved by processing in collaboration with an operating system, an other application program, or the like, based on the instruction of the program.

In addition, in a case where the program is distributed in the market, the program can be stored in a portable recording medium and distributed, or can be transferred to a server computer connected via a network such as the Internet. In this case, needless to say, a storage device of the server computer is also included in the present disclosure.

What is claimed is:

1. An information processing apparatus comprising:
one or more controllers; an operation acceptor; a displayer; and a communicator that provides a network port for connecting to a network, wherein
the one or more controllers accept an instruction to disable a first function via the operation acceptor, determine existence or non-existence of a second function that uses the network port used by the first function and that is different from the first function, and decide whether or not to disable the network port, based on a result of the determination.

2. The information processing apparatus according to claim 1, wherein
the one or more controllers display, on the displayer, a message inquiring whether or not to disable the network port, based on a result of the determination, and decide whether or not to disable the network port, based on an instruction being input via the operation acceptor in response to the message.

3. The information processing apparatus according to claim 2, wherein the one or more controllers disable the second function when the network port is disabled.

4. The information processing apparatus according to claim 3, wherein, when the second function is disabled, the one or more controllers display, on the displayer, a setting screen for setting an other network port used by the second function.

5. The information processing apparatus according to claim 1, wherein the one or more controllers decide whether or not to disable both the first function and the network port, depending on a result of the determination.

6. The information processing apparatus according to claim 5, wherein, when the first function and the network port are not disabled, the one or more controllers display, on the displayer, a message regarding a reason why the first function is not disabled.

7. A method of controlling an information processing apparatus comprising:
accepting an instruction to disable a first function;
determining existence or non-existence of a second function that uses a network port used by the first function and that is different from the first function; and
deciding whether or not to disable the network port, based on a result of the determination.
